(19) United States
(12) Patent Application Publication
(10) Pub. No.: US 2003/0047041 A1
(43) Pub. Date: Mar. 13, 2003

(54) Valve handle wrench

(75) Inventor: Michael R. Trout, Richwood, OH (US)

Correspondence Address: RANKIN, HILL, PORTER & CLARK LLP, 700 HUNTINGTON BUILDING, 925 EUCLID AVENUE, CLEVELAND, OH, 44115-1405, US

(73) Assignee: Honda of America Mfg., Inc., Marysville, OH (US)

(21) Appl. No.: 09/954,689

(22) Filed: Sep. 12, 2001

(51) Int. Cl. B25B 13/48

(52) U.S. Cl. 81/176.15

(57) ABSTRACT

An adaptor for actuating a valve by rotating a handwheel, the handwheel including a series of radially extending spokes. The adaptor includes a socket, an adaptor body, and a plurality of pegs. The socket and pegs are aligned with an axis of rotation of the body, but extend in relatively opposite directions. The pegs are adapted to engage lateral surfaces of the spokes such that, when a ratchet is inserted into the socket and used to rotate the adaptor about the axis of rotation, the pegs cause the adaptor handle to rotate with the adaptor, actuating the valve.

### BACKGROUND OF THE INVENTION

1. Field of the Invention

The present invention generally relates to valve handles and, more particularly, to adaptors for actuating or rotating valve handles.

2. Description of Related Art

Regulators, gate valves, and other types of valves typically have rotary valve stems that are secured to a handwheel, which serves as a handle to turn the valve stem, and hence the valve, between the opened and closed positions. The handwheel includes a hub secured to the valve stem, a circular outer handle, and spokes extending radially from the hub to the circular handle. The user conventionally grips the handle and pushes/pulls same to rotate the hub and, thus, the valve stem. Although these valves are intended to be hand operated, and the circular handle provides a certain amount of leverage or torque to the user, this is often inadequate, and the valve cannot be moved. There are many reasons that the valve may be “frozen”: spring tension, high back pressure, corrosion, high surface temperature, and physical position/location resulting in inaccessibility for the user to properly rotate the handwheel. The user's attempts to force the valve to move may cause burns, blisters, and other ergonomic or work injuries.

Therefore, it has been common to use toothed tools such as pliers or vise-grips to grasp and turn the handle, hub, or valve stem. However, these tools routinely slip, damaging the valve or valve stem. Other attempts, such as embodied by U.S. Pat. No. 4,848,194, entail providing a coupling that is secured to the circular handle and receives a wrench, such as a crescent wrench, to provide additional leverage or torque for operating the valve. Other patents, such as U.S. Pat. No. 4,991,469 and U.S. Pat. No. 4,715,252 teach specially adapted wrenches that are designed to engage the handle and spoke to assist in turning the handwheel. While such wrenches may work satisfactorily, they require space that may not be available in many instances.

Expired U.S. Pat. No. 3,835,736 teaches a two-piece adaptor that is bolted to the handwheel and surrounds the hub. The pieces of the adaptor are on opposite sides of the handwheel. One piece of the adaptor includes an upstanding boss that is adapted to be engaged by a ratchet wrench to actuate the valve. U.S. Pat. No. 5,203,240 discloses another valve actuating device that employs a ratchet-type drive mechanism.

As can be seen from the foregoing, many attempts have been made to solve the problems associated with frozen valves, some of which employ ratchet wrenches. Yet, there remains a need in the art for a simple adaptor that will make it possible to actuate a conventional handwheel-driven valve by means of a conventional ratchet.

### SUMMARY OF THE INVENTION

The present invention is directed toward a simple adaptor to permit actuation of a conventional handwheel-driven valve by means of a conventional ratchet. The present invention is further directed toward a method of valve actuation using a ratchet.

In accordance with the present invention, an adaptor includes a socket, an adaptor body, and series of pegs extending from the adaptor body. The adaptor body has a rotational axis that is aligned with the socket. The pegs are aligned with, but radially spaced from, the rotational axis.

In further accordance with the present invention, the body of the adaptor has a first side from which projects the socket, and a second side from which projects the pegs. The body is adapted to lay upon an outer surface of a handwheel while the pegs project between the spokes of the handwheel. When the adaptor is rotated, the pegs engage the lateral sides of the handwheel spokes. Accordingly, rotation of the adaptor by means of a ratchet applying force to the adaptor socket causes the adaptor and handwheel to rotate in common. The socket is aligned with the axis of the handwheel, but spaced therefrom.

In accordance with another aspect of the invention, a method for actuating a valve is provided. The method includes the steps of providing an adaptor, the adaptor including an adaptor body, a socket extending in a first direction from the adaptor body, and a series of pegs extending from the adaptor body in a second direction. The adaptor is applied to the handwheel such that the pegs extend between spokes of the handwheel. A ratchet is inserted into the adaptor socket, and is used to rotate the adaptor, and hence the valve handwheel.

### BRIEF DESCRIPTION OF THE DRAWINGS

These and further features of the invention will be apparent with reference to the following description and drawings, wherein:

FIG. 1 is an exploded perspective view of a valve handwheel, a ratchet, and an adaptor according to the present invention;

FIG. 2 is a side elevational view of the adaptor; and,

FIG. 3 is a bottom and front perspective view of an adaptor according to the present invention.

### DETAILED DESCRIPTION OF THE PREFERRED EMBODIMENT

With reference to the drawings, an adaptor 10 according to the present invention is shown to include an adaptor body 12, a socket 14, and a plurality of pegs 16. The adaptor body 12 has a first side 18, a second side 20, and an axis of rotation about which the adaptor body 12 rotates in use, as will be apparent from the following description. The socket 14 extends or projects from the adaptor body first side 18, and the socket 14 is co-axial with the axis of rotation. The socket 14 is designed and adapted to receive a drive head of a conventional ratchet wrench 22. Insofar as ratchet wrenches are well known in the art, a description of ratchets and their methods of operation is not provided hereinafter.

The pegs 16, which extend from the second side 20 of the adaptor body 12, are generally aligned with, but radially spaced from, the rotational axis. The pegs 16 are designed to engage a valve handwheel to force the handwheel to rotate with the adaptor 10, as will be described hereinafter.

Preferably, the socket 14 and pegs 16 are secured to the adaptor body 12 such that an adaptor 10 having a unitary or integral structure results. Such securement is preferably the result of welding, but may also be the result of other means of mechanical affixation now known or hereafter developed. For example, the pegs 16 may be headed bolts that are threaded only at their base and, as such, are threadably inserted through tapped holes in the adaptor body 12, from the first side 18 of the adaptor body 12 to the second side 20 of the adaptor body 12. Moreover, although the socket 14 is preferably welded to the first side 18 of the adaptor body 12, it is also contemplated that mechanical fastener(s), such as threaded fasteners or other means of securement may be used.

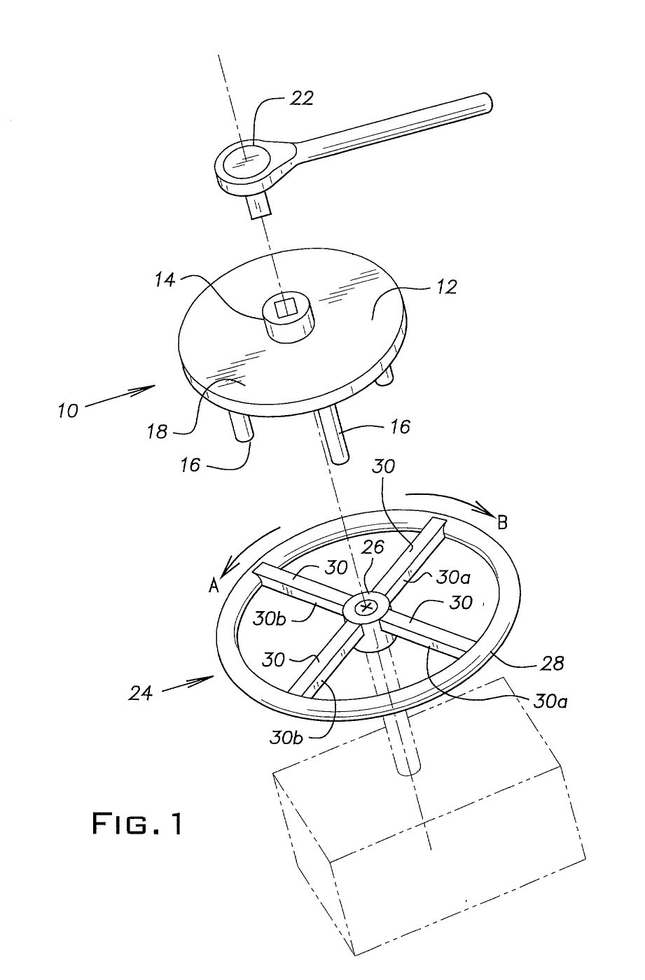

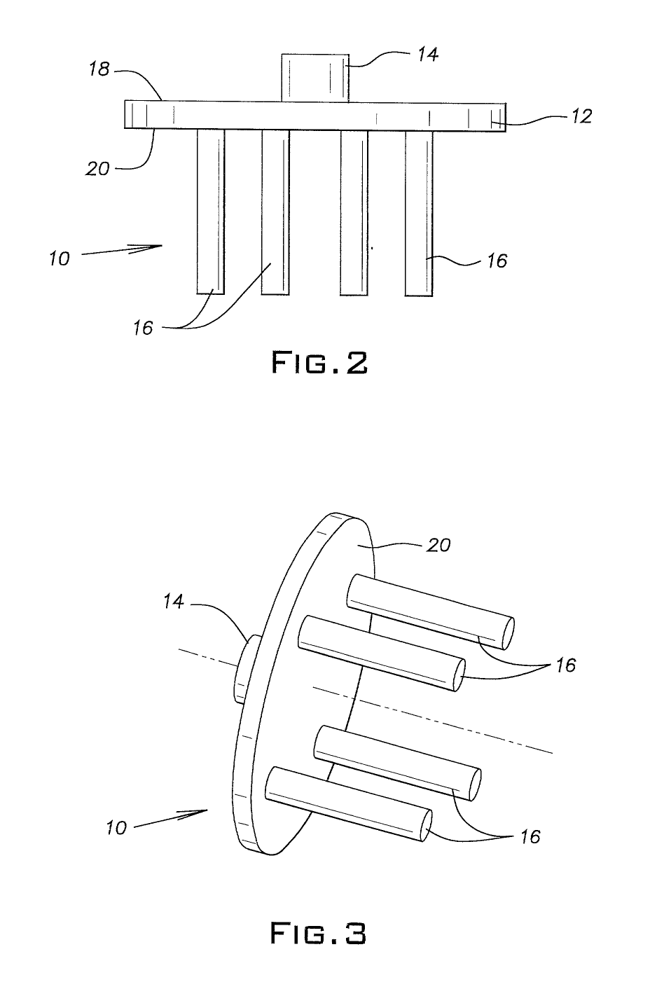

The adaptor 10 of the present invention is intended to be used on rotary valves having a hand-operated handwheel 24. Conventional handwheels 24, as shown in FIG. 1, include an inner hub, an outer circular rim or handle 28, and a plurality of spokes 30 extending radially between the hub and the handle 28 of the handwheel 24. Each of the spokes 30 includes first and second lateral surfaces 30a, 30b. The first lateral surface 30a of the spokes 30 is engaged when the adaptor 10 is turned in a first direction (A) while the second lateral surface 30b of the spokes 30 is engaged when the adaptor 10 is turned in a second, opposite direction (B).

In use, the adaptor 10 is placed over a handwheel 24 such that the second side 20 of the adaptor 10 is in face-to-face contact with the outer or exposed side of the handwheel 24. The pegs 16 extend between the spokes 30 and engage one of the first and the second lateral sides 30a, 30b of the spokes 30, depending upon the intended direction of valve/adaptor rotation (A or B). Due to the aforementioned positioning of the adaptor 10, the adaptor socket 14 is accessible for driving engagement with the ratchet 22. The pegs 16 force the valve handwheel 24 and, hence, the valve, to rotate in the desired direction. It is noted that as one switches the direction of adaptor rotation (i.e., from direction A to direction B), there will be a period of lost motion wherein the adaptor rotates freely as the pegs move between the spokes while the handwheel remains stationary.

The present invention has been described herein with particularity, but it is noted that the scope of the invention is not limited thereto. Rather, the present invention is considered to be possible of numerous modifications, alterations, and combinations of parts and, therefore, is only defined by the claims appended hereto. For example, although the adaptor body 12 has been shown herein as being generally circular, it is considered apparent that other shapes may be used with equal functionality. Moreover, the number of pegs 16 for a handwheel 24, and hence the number of pegs 16 for the adaptor 10, are not limited to the number disclosed and illustrated herein. Rather, the number of pegs 16 used will be determined to optimize engagement between the adaptor (pegs) and the handwheel (spokes) and, accordingly, is not limited to the number of pegs or the peg orientation disclosed herein.

What is claimed is:

1. An adaptor for use in actuating a valve by engagement with a valve handwheel, said adaptor including:
an adaptor body defining an axis of rotation and having a first side and an opposite second side;
a socket extending from said first side and aligned with said axis;
a plurality of pegs extending from said second side, each of said pegs being aligned with, but spaced radially from, said axis;
wherein said adaptor is positionable on the handwheel such that said pegs engage said handwheel and cause said handwheel to rotate with said adaptor.

2. The adaptor according to claim 1, wherein said adaptor socket is adapted to receive a drive head from a conventional ratchet.

3. The adaptor according to claim 2, wherein said adaptor comprises four pegs.

4. The adaptor according to claim 2, wherein said pegs are adapted to extend between spokes of the handwheel, and to engage lateral sides of the spokes to rotate the handwheel.

5. The adaptor according to claim 4, wherein said adaptor comprises four pegs.

6. A method of actuating a valve with an adaptor, said valve having a valve body and a handwheel, said valve body having a valve stem extending therefrom, said valve stem being rotatably linked to a hub of said handwheel, said handwheel further providing a circular handle and a plurality of spokes that extend radially from the hub to the handle, said adaptor including a socket, an adaptor body, and a plurality of pegs, the method comprising:
inserting said pegs between said spokes;
positioning said adaptor body against an outer side of said handwheel;
inserting a ratchet into said adaptor socket;
turning said adaptor socket with said ratchet and thereby causing said adaptor to rotate;
engaging a lateral side of said spokes with said adaptor pegs;
further turning said adaptor socket with said ratchet and thereby causing said handwheel to rotate.

7. The method according to claim 6, wherein said handwheel spokes have a first lateral surface and a second lateral surface, said method including the further steps of:
turning said adaptor in a first direction to cause said pegs to engage the first lateral surface of said spokes to open said valve; and,
turning said adaptor in a second direction to cause said pegs to engage the second lateral surface of said spokes to close said valve.

8. The method according to claim 7, wherein when a direction of adaptor and handwheel rotation is reversed there is a period of lost motion in that the adaptor rotates while the handwheel remains stationary.
